(19) United States
(12) Patent Application Publication
(10) Pub. No.: US 2005/0180378 A1
(43) Pub. Date: Aug. 18, 2005

(54) Multimedia broadcast/multicast service apparatus and paging method in mobile communication system

(75) Inventors: Young Dae Lee, Kyoungki-do (KR); Seung June Yi, Seoul (KR); Sung Duck Chun, Anyang city (KR)

Correspondence Address: LEE, HONG, DEGERMAN, KANG & SCHMADEKA, 801 S. Figueroa Street, 14th Floor, Los Angeles, CA, 90017, US

(73) Assignee: LG Electronics Inc.

(21) Appl. No.: 11/029,238

(22) Filed: Jan. 4, 2005

(30) Foreign Application Priority Data
Jan. 9, 2004 (KR) 2004-0001594

(51) Int. Cl. H04Q 7/00

(52) U.S. Cl. 370/345

(57) ABSTRACT

In an apparatus and paging method for a broadcast and multicast service (MBMS) in a mobile communication system, a network transmits a terminal paging indication channel (PICH) frame and an MBMS paging indication channel (MICH) frame such that the MICH frame is transmitted after a certain time from the transmission of the PICH frame. A mobile terminal receives the PICH frame during a discontinuous reception (DRX) cycle, and only when MICH indication information is included in the PICH frame does the mobile terminal recieve the MICH frame. Thus, power consumption of the mobile terminal is considerably reduced.

### CROSS-REFERENCE TO RELATED APPLICATIONS

Pursuant to 35 U.S.C. § 119(a), this application claims the benefit of earlier filing date and right of priority to Korean Application No. 2004-0001594 filed on Jan. 9, 2004, the contents of which is hereby incorporated by reference herein in its entirety.

### BACKGROUND OF THE INVENTION

1. Field of the Invention

The present invention relates to a wireless mobile communication system, and more particularly, to a paging apparatus and method for a Multimedia Broadcast/Multicast Service (MBMS) in a wireless communication system.

2. Description of the Related Art

Generally, a method of calling one or more mobile terminals for a certain purpose by a network is referred to as paging. Paging contributes to the reduction of power consumption by allowing a mobile terminal in a sleep mode to be awakened only if necessary. Normally, the mobile terminal is in a sleep mode. When a paging signal is received from the network, the mobile terminal wakes up to perform a function requested by the network.

In order for the mobile terminal in the sleep mode to recognize the paging signal, the mobile terminal must wake up periodically to check whether paging information has been received. Such periodical waking up, in contrast to always being in an awakened mode, is called a Discontinuous Reception (DRX) method. A telecommunication system, such as the Universal Mobile Telecommunications System (UMTS), which is a European IMT-2000 system, adopts the DRX method as a paging method of a mobile terminal.

A paging method defined in the UMTS, such as the DRX method, is shown in FIG. 1. In the UMTS, in order for the mobile terminal to effectively perform the DRX, a two-step paging method is employed. Specifically, the DRX method uses a Paging Indicator Channel (PICH) in the first step and a Paging Channel (PCH) in the second step.

The mobile terminal in the sleep mode periodically receives the PICH, a physical channel, using the DRX. As such, the mobile terminal does not continuously receive a PICH frame, but receives one PICH frame having a length of 10 ms every DRX cycle length. A DRX cycle length may be equal to the length of several PICH frames. Accordingly, power consumption is reduced.

As shown in FIG. 1, one DRX cycle length may equal the length of 8 PICH frames. If the length of the PICH frame is 10 ms long, then the mobile terminal wakes up every 80 ms to receive the PICH frame. One PICH frame comprises a total of 300 bits. Currently, the network transmits paging indication information using only the front 288 bits of the PICH frame. The last 12 bits is left unused. Notably, information found in the PICH frame is referred to as “paging indication information” and not “paging information” because the PICH frame does not transmit information bearing actual paging content. Rather the PICH frame only transmits information, for indicating to a mobile terminal to read a PCH. The information for indicating to read the PCH is referred to as a Paging Indicator (PI). Actual paging information is transmitted through the PCH. One PICH frame may comprise several PIs which transmit paging indication information for a mobile terminal group.

A specific mobile terminal recognizes its paging indication information (PI) included in the PICH frame using a mobile terminal identity (UE identity). Namely, the mobile terminal determines the PICH frame and the PI to receive by conducting a modular operation between the UE identity and a constant value determined by a network. The modular operation obtains a remainder value by dividing the UE identity by the constant value. The mobile terminal then receives the PICH frame and the PI having the corresponding remainder value. Preferably, each mobile terminal receives a different PICH frame and PI. However, if there are many mobile terminals in a cell, several mobile terminals may have the same remainder value obtained by dividing the UE identity by the constant value. If so, then one PI transmits paging indication information with respect to one or more terminals. Accordingly, while a specific terminal receives a PI allocated to the terminal itself, the PI may have in fact paged a different terminal, and not the specific terminal.

Because the mobile terminal cannot know whether the received PI has actually paged itself, the mobile terminal receives a Secondary Common Control Physical Channel (SCCPCH) carrying the PCH after a certain time lapse (τ_{PICH}) from receiving the PICH frame with the PI. Ultimately, the mobile terminal receives an associated PCH frame through the SCCPCH. Here, the PCH frame is referred to as an “associated PCH frame” because one PICH, one SCCPCH and one PCH are all in a 1:1:1 relationship. Namely, when the mobile terminal receives the PI through a certain PICH, it also receives the SCCPCH and the PCH included therein according to the determined relationship.

The mobile terminal cannot know whether the received PI actually paged the mobile terminal until the mobile terminal receives the associated PCH frame having the UE identity. If the mobile terminal's UE identity is included in the received PCH frame, the mobile terminal performs a follow-up operation according to the paging information included in the PCH frame. If, however, the PCH frame does not include the mobile terminal's UE identity, the mobile terminal stops operation and goes back to the sleep mode to perform the DRX.

Two-step paging using the PICH and the PCH in the UMTS is advantageous over a one-step paging method. In one-step paging, both the UE identity and the paging information are included in the PICH. Thus, the amount of information transmitted through the PICH is increased. Accordingly, the mobile terminal must awaken for a long duration to receive the increased amount of information, therefore degrading the advantages of the DRX.

In contrast, in two-step paging in the UMTS, very small information is transmitted through the PICH during the first-step of the two-step paging method. Actual paging information is transmitted through the PCH during the second-step. Thus, the DRX effect of the mobile terminal is maximized. However, because several mobile terminals share one PI in a cell, a false alarm or false paging indication may occur in a specific mobile terminal in the two-step paging method. But, because a maximum 144 PIs can be included in one PICH frame and the DRX cycle length can be extended up to a maximum 512 frames, there is little possibility of a false alarm occurring. If a false alarm were to occur, power consumption would be small so as to be disregarded.

As aforementioned, the related art paging method used for calling a specific terminal is also adopted for a multimedia broadcast and multicast service. The multimedia broadcast and multicast service is not limited to providing a service to a specific terminal; rather, it refers to a technique for providing the same service to multiple terminals. Paging allows mobile terminals desiring to receive a specific service to receive service-related information such as information regarding the start of the service. The paging method used for the multimedia broadcast and multicast service is referred to as Multimedia Broadcast/Multicast Service (MBMS) paging in the UMTS. Compared to terminal paging which pages a specific terminal, MBMS paging pages several terminals simultaneously.

For MBMS paging, the UMTS uses an MBMS PICH (MICH), which is a PICH for the MBMS, in addition to the PICH for terminal paging. Accordingly, a mobile terminal which has subscribed to a specific MBMS service wakes up from a sleep mode periodically and receives the PICH and the MICH simultaneously. If the PI is received through the PICH, the mobile terminal receives the PCH as in the related art. When an MBMS Paging Indicator (MI), which is a PI for the MBMS, is received through the MICH, the mobile terminal receives the MBMS Control Channel (MCCH) containing control information of the MBMS service. If the PI and the MI are simultaneously received and the mobile terminal can deal well with it, the mobile terminal receives the PCH and the MCCH simultaneously. Otherwise, the mobile terminal preferentially receives the PCH for the terminal paging.

The network transmits the PICH and the MICH at every frame so that the mobile terminal can determine whether there is information to be received. In this respect, it is noted that even if there is no information to be received by the terminal, the network still transmits the PICH and the MICH at every frame. This is because the terminal discriminates a physical channel as either 1 or −1. Thus, if the network does not transmit the PICH or the MICH, the terminal may make an erroneous determination. Therefore, the network transmits the PICH and the MICH at every frame to accurately give information to the mobile terminal.

A process in which terminals having subscribed to a specific MBMS service receive MBMS paging and read an MCCH while in a DRX state is illustrated in FIG. 2. As shown, mobile terminals 1 and 2 (UE1 and UE2, respectively) subscribed to the specific service wake up according to their UE identities from a sleep mode and receive the PICH and the MICH frame allocated to them. The PICH frame is received using the same method as the related art terminal paging method. If there is a PI calculated by the UE identity in the received PICH frame, the mobile terminal recognizes that terminal paging indication information has been received and subsequently receives an associated PCH frame.

MBMS paging performs together with the related art terminal paging. A mobile terminal subscribed to an MBMS service wakes up according to its UE identity to receive the PICH frame. The mobile terminal also receives the MICH frame simultaneously transmitted during the same time interval. Specifically, when the terminal wakes up, it must read both the PICH frame and the MICH frame to receive the MBMS. In contrast to a mobile terminal not receiving MBMS services, the mobile terminal subscribed to an MBMS service must have the capability to simultaneously receive the PICH and the MICH.

The MICH frame is similar to the PICH frame in that it includes an MBMS Paging Indicator (MI). However, the MICH frame is different in that the MI uses the entire 300 bits of the frame. Such use is in preparation for a case where MBMS service increases. Which MI of a MICH frame the mobile terminal receives depends on an MBMS service identifier. This is very different from selecting a PI from the PICH frame. As stated above, the PI is determined by assessing a remainder value calculated by dividing the UE identity by a constant value determined by the network, wherein each terminal has a different PI. Comparatively, the MI is determined by assessing a remainder value calculated by dividing the service identifier by a constant value determined by the network. Thus, all the terminals that have subscribed to the specific service have the same MI.

As shown in FIG. 2, the mobile terminals 1 and 2 (UEs 1 and 2) have a different PI position in each PICH but have the same MI position in each MICH. For the reasons stated above, the PICH and MICH frames of the network are different in their construction. Specifically, because each mobile terminal differently determines the PI within the PICH frame, each PICH frame comprises a different PI. However, because every terminal subscribed to the specific service commonly determines the MI within the MICH frame, every MICH frame in one DRX cycle length comprises the same MI.

If the MI of a service, for which the terminal has subscribed to, has been set in the received MICH frame, the terminal receives the SCCPCH including the MCCH in the next DRX cycle. A reception time interval from the MICH frame up to the MCCH is not determined because the MCCH is common for every terminal receiving the MBMS service even though a receiving time of the MICH frame is different for each terminal. Accordingly, if the terminals receive the MICH frame during an early part of the DRX cycle, they must wait a long time prior to receiving the MCCH during the next DRX cycle. If the terminals receive the MICH frame during a later part of the DRX cycle, they can receive the MCCH immediately during the next DRX cycle. Upon receiving the MCCH, the terminals check the information with respect to the corresponding MBMS and start receiving the MBMS.

In the related art MBMS paging method, when the terminal desires to receive the specific MBMS, it periodically receives the PICH frame and the MICH frame simultaneously until the service is started. If a terminal has not subscribed to the MBMS, it receives only one PICH frame when it wakes up. But, if the terminal has subscribed to the MBMS, it should receive the two channels, PICH and MICH, simultaneously. Consequently, an additional receiver must be implemented on the mobile terminal for receiving both channels simultaneously. This causes an additional burden in the construction of the mobile terminal.

Additionally, a problem is present in the related art MBMS paging method regarding the power consumption of the terminal. That is, when the mobile terminal wakes up, it must receive the two channels (PICH and MICH) simultaneously. Thus, the power consumed by the mobile terminal, subscribed to the MBMS, when it wakes up is twice compared to that of the terminal having not subscribed to the MBMS service. Given that it may take anywhere from a few seconds or less to several days or more until a service is actually started after the mobile terminal subscribes to the service, conservative power consumption is preferable in case a long receiving standby time is necessary. However, if the mobile terminal simultaneously receives the MICH frame together with the PICH frame as in the related art, power consumption of the mobile terminal is increased. Hence, the receiving standby time shortened.

Thus, a new MBMS paging method that reduces power consumption of the mobile terminal without requiring additional performance of the terminal to effectively provide the MBMS is much required.

### SUMMARY OF THE INVENTION

The present invention is directed to a paging method for a multimedia broadcast and multicast service (MBMS) in a mobile communication system.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a method for receiving a point-to-multipoint service in a wireless communication system, the method comprising waking during a discontinuous reception cycle length to receive a paging indication channel frame, the paging indication channel frame comprising a paging indicator and a point-to-multipoint indication channel indicator, reading the paging indicator contained in the paging indication channel frame, reading the point-to-multipoint indication channel indicator contained in the paging indication channel frame, receiving a point-to-multipoint indication channel frame if the point-to-multipoint indication channel indicator contained in the paging indication channel frame is associated with the point-to-multipoint service subscribed by a mobile terminal, the point-to-multipoint indication channel frame comprising a point-to-multipoint notification indicator, and receiving point-to-multipoint control information for the point-to-multipoint service subscribed by the mobile terminal if the point-to-multipoint notification indicator contained in the point-to-multipoint indication channel frame is associated with the point-to-multipoint service subscribed by the mobile terminal.

The method further comprises returning to a sleep mode if the paging indicator and the point-to-multipoint indication channel indicator contained in the paging indication channel frame are not associated with the mobile terminal.

In one aspect of the present invention, the point-to-multipoint indication channel frame is received after a certain time from the reception of the paging indication channel frame. Moreover, the point-to-multipoint indication channel indicator is contained in the last 12 bits of the paging indication channel frame. Also, the mobile terminal reads the point-to-multipoint indication channel frame only when the point-to-multipoint notification indicator is included in the point-to-multipoint indication channel frame.

According to one aspect of the invention, the method further comprises calculating a remainder value by dividing the mobile terminal's UE identity by a constant value determined by a network, determining whether the paging indicator is associated with the mobile terminal by comparing the paging indicator with the remainder value, and receiving an associated paging channel frame containing mobile terminal paging information if the paging indicator is determined to be associated with the mobile terminal.

According to another aspect of the invention, the method further comprises calculating a remainder value by dividing a point-to-multipoint service identifier by a constant value determined by a network, determining whether the point-to-multipoint notification indicator is associated with the point-to-multipoint service subscribed by the mobile terminal by comparing the point-to-multipoint notification indicator with the remainder value, and receiving a point-to-multipoint control channel containing the point-to-multipoint control information if the point-to-multipoint notification indicator is determined to be associated with the point-to-multipoint service subscribed by the mobile terminal. Preferably, the point-to-multipoint control channel is received after a certain time from the beginning of the next discontinuous reception cycle.

In another embodiment of the invention, a method for receiving a point-to-multipoint service in a wireless communication system comprises waking during a discontinuous reception cycle length to receive a paging indication channel frame, the paging indication channel frame comprising a paging indicator and a plurality of point-to-multipoint indication channel indicators, reading the paging indicator contained in the paging indication channel frame, reading the plurality of point-to-multipoint indication channel indicators contained in the paging indication channel frame, receiving a point-to-multipoint indication channel frame if at least one of the plurality of point-to-multipoint indication channel indicators contained in the paging indication channel frame is associated with the point-to-multipoint service subscribed by a mobile terminal, the point-to-multipoint indication channel frame comprising at least one point-to-multipoint notification indicator group able to be indicated by at least one of the plurality of point-to-multipoint indication channel indicators contained in the paging indication channel frame, and receiving point-to-multipoint control information for the point-to-multipoint service subscribed by the mobile terminal if at least one point-to-multipoint notification indicator in the at least one point-to-multipoint notification indicator group contained in the point-to-multipoint indication channel frame is associated with the point-to-multipoint service subscribed by the mobile terminal.

The method further comprises returning to a sleep mode if the paging indicator and the plurality of point-to-multipoint indicator channel indicators contained in the paging indication channel frame are not associated with a service subscribed by the mobile terminal.

In one aspect of the present invention, the point-to-multipoint indication channel frame is received after a certain time from the reception of the paging indication channel frame. Moreover, the relationship between the at least one point-to-multipoint notification indicator group contained in the point-to-multipoint indication channel frame and the plurality of point-to-multipoint indication channel indicators contained in the paging indication channel frame is signaled to the mobile terminal by a network.

In another aspect of the present invention, the plurality of point-to-multipoint indication channel indicators are contained in the last 12 bits of the paging indication channel frame, wherein each of the plurality of point-to-multipoint indication channel indicators is formed with less than 12 bits. Preferably, two point-to-multipoint indication channel indicators comprising 6 bits each are included in the paging indication channel frame, wherein the two point-to-multipoint indication channel indicators respectively indicate two point-to-multipoint notification indicator groups in the point-to-multipoint indication channel frame.

According to one aspect of the present invention, the mobile terminal reads the point-to-multipoint indication channel frame only when a point-to-multipoint notification indicator is included in the point-to-multipoint indication channel frame.

The method may further comprise calculating a remainder value by dividing the mobile terminal's UE identity by a constant value determined by a network, determining whether the paging indicator is associated with the mobile terminal by comparing the paging indicator with the remainder value, and receiving an associated paging channel frame containing mobile terminal paging information if the paging indicator is determined to be associated with the mobile terminal.

The method may also further comprise calculating a remainder value by dividing a point-to-multipoint service identifier by a constant value determined by a network, determining whether the at least one point-to-multipoint notification indicator is associated with the point-to-multipoint service subscribed by the mobile terminal by comparing the at least one point-to-multipoint notification indicator with the remainder value, and receiving a point-to-multipoint control channel containing the point-to-multipoint control information if the at least one point-to-multipoint notification indicator is determined to be associated with the point-to-multipoint service subscribed by the mobile terminal. The point-to-multipoint control channel may be received after a certain time from the beginning of the next discontinuous reception cycle.

Furthermore, point-to-multipoint notification indicators are grouped together in the at least one point-to-multipoint notification indicator group so that each of the plurality of point-to-multipoint indication channel indicators contained in the paging indication channel frame can indicate a specific point-to-multipoint notification indicator group.

Specifically, the point-to-multipoint notification indicators are grouped such that the point-to-multipoint notification indicators included in the front half of the point-to-multipoint indication channel frame are designated a first group and the point-to-multipoint notification indicators included in the rear half of the point-to-multipoint indication channel frame are designated a second group.

Additionally, the point-to-multipoint notification indicators may be grouped such that the even-numbered point-to-multipoint notification indicators included in the point-to-multipoint indication channel frame are designated a first group and the odd-numbered point-to-multipoint notification indicators included in the point-to-multipoint indication channel frame are designated a second group.

In another embodiment of the present invention, a method for transmitting a point-to-multipoint service in a wireless communication system comprises transmitting a paging indication channel frame, the paging indication channel frame comprising a paging indicator, and transmitting at least one point-to-multipoint indication channel frame after a certain time from the transmission of the paging indication channel frame, the at least one point-to-multipoint indication channel frame comprising at least one point-to-multipoint notification indicator.

Preferably, the paging indication channel frame further comprises a point-to-multipoint indication channel indicator. The method further comprises transmitting point-to-multipoint control information for the point-to-multipoint service after transmitting the point-to-multipoint indication channel frame having the at least one point-to-multipoint notification indicator corresponding to the point-to-multipoint control information.

According to one aspect of the present invention, the at least one point-to-multipoint indication channel frame is transmitted only when point-to-multipoint paging information is included in the point-to-multipoint indication channel frame.

In another embodiment of the present invention, a method for transmitting a point-to-multipoint service in a wireless communication system comprises transmitting a paging indication channel frame during a discontinuous reception cycle length of a mobile terminal, the paging indication channel frame comprising a paging indicator and a point-to-multipoint indication channel indicator, transmitting a point-to-multipoint indication channel frame if the point-to-multipoint indication channel indicator contained in the paging indication channel frame is associated with the point-to-multipoint service subscribed by a mobile terminal, the point-to-multipoint indication channel frame comprising a point-to-multipoint notification indicator, and transmitting point-to-multipoint control information for the point-to-multipoint service subscribed by the mobile terminal if the point-to-multipoint notification indicator contained in the point-to-multipoint indication channel frame is associated with the point-to-multipoint service subscribed by the mobile terminal.

Preferably, the point-to-multipoint indication channel frame is transmitted after a certain time from the transmission of the paging indication channel frame. The control information is transmitted through a point-to-multipoint control channel, the point-to-multipoint control channel being transmitted after a certain time from the beginning of the next discontinuous reception cycle.

In another embodiment of the present invention, a method for transmitting a point-to-multipoint service in a wireless communication system comprises transmitting a paging indication channel frame during a discontinuous reception cycle length of a mobile terminal, the paging indication channel frame comprising a paging indicator and a plurality of point-to-multipoint indication channel indicators, transmitting a point-to-multipoint indication channel frame if at least one of the plurality of point-to-multipoint indication channel indicators contained in the paging indication channel frame is associated with the point-to-multipoint service subscribed by the mobile terminal, the point-to-multipoint indication channel frame comprising at least one point-to-multipoint notification indicator group able to be indicated by at least one of the plurality of point-to-multipoint indication channel indicators contained in the paging indication channel frame, and transmitting point-to-multipoint control information for the point-to-multipoint service subscribed by the mobile terminal if at least one point-to-multipoint notification indicator in the at least one point-to-multipoint notification indicator group contained in the point-to-multipoint indication channel frame is associated with the point-to-multipoint service subscribed by the mobile terminal.

Preferably, the relationship between the at least one point-to-multipoint notification indicator group contained in the point-to-multipoint indication channel frame and the plurality of point-to-multipoint indication channel indicators contained in the paging indication channel frame is signaled to the mobile terminal by a network.

Furthermore, point-to-multipoint notification indicators are grouped together in the at least one point-to-multipoint notification indicator group so that each of the plurality of point-to-multipoint indication channel indicators contained in the paging indication channel frame can indicate a specific point-to-multipoint notification indicator group.

According to one aspect of the invention, a network transmits the at least one point-to-multipoint notification indicator group only if a corresponding point-to-multipoint indication channel indicator is included in the paging indication channel frame.

In another embodiment of the invention, an apparatus for receiving a point-to-multipoint service in a wireless communication system comprises a processor adapted to wake the apparatus during a discontinuous reception cycle length and a receiver adapted to receive a paging indication channel frame, the paging indication channel frame comprising a paging indicator and a point-to-multipoint indication channel indicator, the processor adapted to read the paging indicator contained in the paging indication channel frame, the processor adapted to read the point-to-multipoint indication channel indicator contained in the paging indication channel frame, the receiver adapted to receive a point-to-multipoint indication channel frame if the point-to-multipoint indication channel indicator contained in the paging indication channel frame is associated with the point-to-multipoint service subscribed by a mobile terminal, the point-to-multipoint indication channel frame comprising a point-to-multipoint notification indicator, and the receiver adapted to receive point-to-multipoint control information for the point-to-multipoint service subscribed by the mobile terminal if the point-to-multipoint notification indicator contained in the point-to-multipoint indication channel frame is associated with the point-to-multipoint service subscribed by the mobile terminal.

In another embodiment of the invention, an apparatus for receiving a point-to-multipoint service in a wireless communication system comprises a processor adapted to wake during a discontinuous reception cycle length and a receiver adapted to receive a paging indication channel frame, the paging indication channel frame comprising a paging indicator and a plurality of point-to-multipoint indication channel indicators, the processor adapted to read the paging indicator contained in the paging indication channel frame, the processor adapted to read the plurality of point-to-multipoint indication channel indicators contained in the paging indication channel frame, the receiver adapted to receive a point-to-multipoint indication channel frame if at least one of the plurality of point-to-multipoint indication channel indicators contained in the paging indication channel frame is associated with the point-to-multipoint service subscribed by a mobile terminal, the point-to-multipoint indication channel frame comprising at least one point-to-multipoint notification indicator group able to be indicated by at least one of the plurality of point-to-multipoint indication channel indicators contained in the paging indication channel frame, and the receiver adapted to receive point-to-multipoint control information for the point-to-multipoint service subscribed by the mobile terminal if at least one point-to-multipoint notification indicator in the at least one point-to-multipoint notification indicator group contained in the point-to-multipoint indication channel frame is associated with the point-to-multipoint service subscribed by the mobile terminal.

In another embodiment of the invention, a network for transmitting a point-to-multipoint service in a wireless communication system comprises a transmitter adapted to transmit a paging indication channel frame, the paging indication channel frame comprising a paging indicator, and the transmitter adapted to transmit at least one point-to-multipoint indication channel frame after a certain time from the transmission of the paging indication channel frame, the at least one point-to-multipoint indication channel frame comprising at least one point-to-multipoint notification indicator.

In another embodiment of the invention, a network for transmitting a point-to-multipoint service in a wireless communication system comprises a transmitter adapted to transmit a paging indication channel frame during a discontinuous reception cycle length of a mobile terminal, the paging indication channel frame comprising a paging indicator and a point-to-multipoint indication channel indicator, the transmitter adapted to transmit a point-to-multipoint indication channel frame if the point-to-multipoint indication channel indicator contained in the paging indication channel frame is associated with the point-to-multipoint service subscribed by a mobile terminal, the point-to-multipoint indication channel frame comprising a point-to-multipoint notification indicator, and the transmitter adapted to transmit point-to-multipoint control information for the point-to-multipoint service subscribed by the mobile terminal if the point-to-multipoint notification indicator contained in the point-to-multipoint indication channel frame is associated with the point-to-multipoint service subscribed by the mobile terminal.

In another embodiment of the invention, a network for transmitting a point-to-multipoint service in a wireless communication system comprises a transmitter adapted to transmit a paging indication channel frame during a discontinuous reception cycle length of a mobile terminal, the paging indication channel frame comprising a paging indicator and a plurality of point-to-multipoint indication channel indicators, the transmitter adapted to transmit a point-to-multipoint indication channel frame if at least one of the plurality of point-to-multipoint indication channel indicators contained in the paging indication channel frame is associated with the point-to-multipoint service subscribed by the mobile terminal, the point-to-multipoint indication channel frame comprising at least one point-to-multipoint notification indicator group able to be indicated by at least one of the plurality of point-to-multipoint indication channel indicators contained in the paging indication channel frame, and the transmitter adapted to transmit point-to-multipoint control information for the point-to-multipoint service subscribed by the mobile terminal if at least one point-to-multipoint notification indicator in the at least one point-to-multipoint notification indicator group contained in the point-to-multipoint indication channel frame is associated with the point-to-multipoint service subscribed by the mobile terminal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a related art paging method of a mobile terminal.

FIG. 2 illustrates a related art process in which mobile terminals having subscribed to a specific MBMS service receive MBMS paging and read an MCCH while in a DRX state.

FIG. 3 illustrates a PICH structure in accordance with one embodiment of the invention.

FIG. 4 illustrates an MBMS paging method of a mobile terminal in accordance with one embodiment of the invention.

FIG. 5 illustrates a method for transmitting a PICH, a MICH and an MCCH by a network in accordance with one embodiment of the invention.

FIG. 6 illustrates a method for using multiple MICH indicators in accordance with one embodiment of the invention.

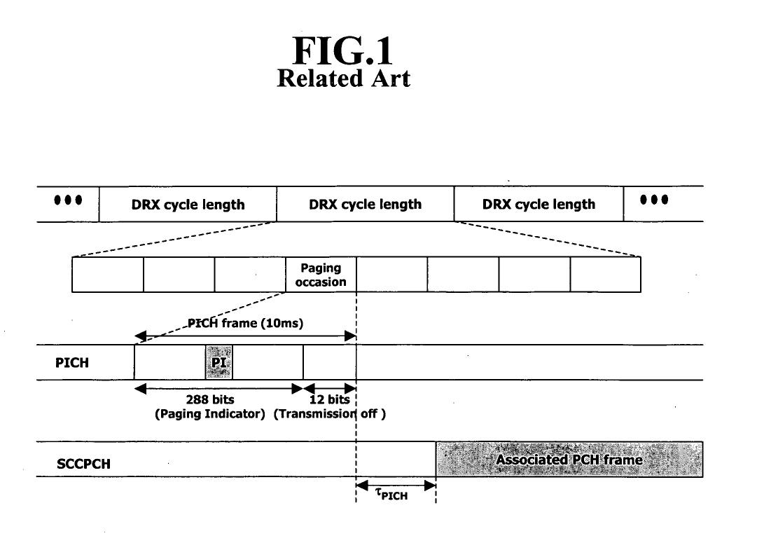

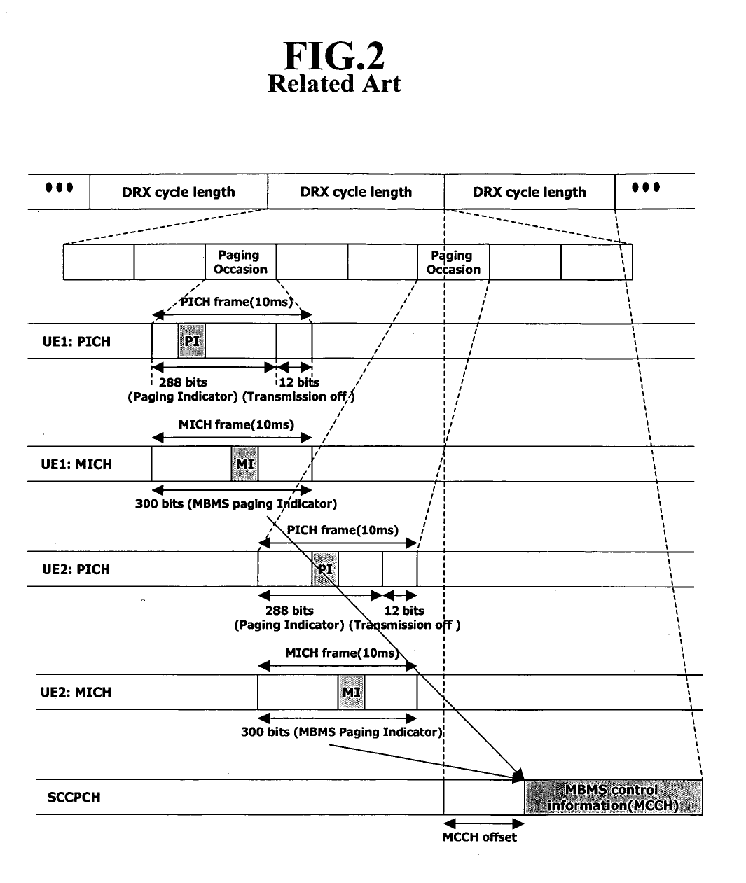

### DETAILED DESCRIPTION OF THE PREFERRED EMBODIMENTS

The present invention is implemented in a mobile communication system, such as the Universal Mobile Telecommunications System (UMTS); however, the present invention may also be applied to a communication system operating in a different specification. Preferred embodiments of the present invention will now be described in detail.

The present invention provides an MBMS paging method capable of effectively using terminal power. For this purpose, a network transmits a PICH frame and its associated MICH frame with a time offset in between transmissions so that the transmissions cannot overlap. The network further transmits a MICH indicator at the last 12 bits (a non-use part) of the PICH frame. A mobile terminal reads the associated MICH frame only when the MICH indicator has been set in the PICH frame. Furthermore, because the time it takes for the mobile terminal to read a MICH frame is very short, the mobile terminal reads the MICH frame only when a point-to-multipoint notification indicator (NI), such as an MBMS paging indicator (MI), is included in the MICH frame. Thus, power consumption of the terminal is reduced. In addition, a network transmits the MICH only when MBMS paging information is included in the MICH. Thus, radio resources that may be wasted unnecessarily due to the transmission of a MICH containing no MBMS paging information can be saved.

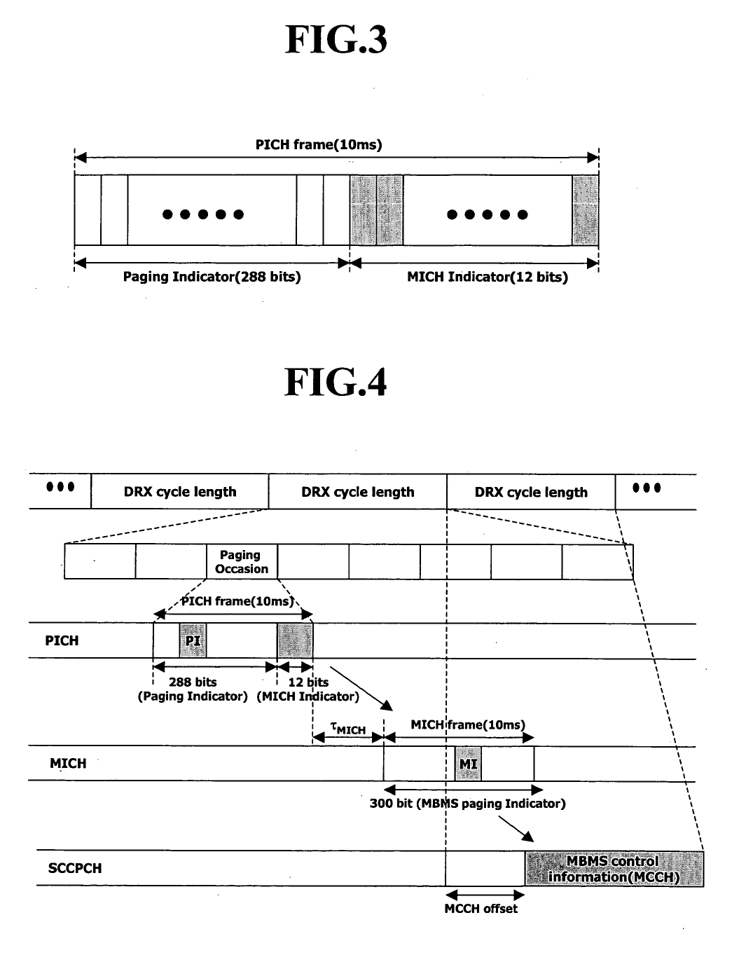

Referring to FIG. 3, a PICH frame structure in accordance with a preferred embodiment of the present invention is illustrated. In the related art PICH frame, only the first 288 bits among the total 300 bits of the PICH frame is used. The rear 12 bits are not used. Comparatively, as shown in FIG. 3, the present invention uses the last 12 bits of the PICH frame for a MICH indicator. The MICH indicator indicates whether a mobile terminal, having received the PICH frame, is to receive an associated MICH frame or not. For reference, the MICH indicator affects only the mobile terminal which has subscribed to the MBMS. Thus, a mobile terminal, which has not subscribed to the MBMS only needs to read the front 288 bits of the PICH frame as in the related art, while the mobile terminal which has subscribed to the MBMS reads all 300 bits.

Referring to FIG. 4, an MBMS paging method of a mobile terminal in accordance with a preferred embodiment of the present invention is illustrated. As shown, a mobile terminal subscribed to a specific MBMS wakes during every DRX cycle length and receives a PICH frame having a length of 10 ms, wherein the mobile terminal determines to receive the PICH frame by evaluating a remainder value calculated by dividing the mobile terminal's UE identity by a constant value determined by a network. Once the PICH frame is received, the mobile terminal compares a PI included in the front 288 bits of the PICH frame with the remainder value. The mobile terminal further checks whether a MICH indicator has been included in the rear 12 bits.

If the mobile terminal's PI and the MICH indicator have not been included in the received PICH frame, the mobile terminal returns to a sleep mode and waits for the next DRX cycle to wake. If, however, the mobile terminal's PI has been included in the received PICH frame, the mobile terminal checks for the existence of terminal paging information and receives an associated PCH frame. In addition, if the MICH indicator has been included in the PICH frame, the terminal checks for the existence of MBMS paging and receives a MICH frame transmitted after a certain time (τMICH) from the reception of the PICH frame.

Upon receiving the MICH frame, the mobile terminal checks an MBMS Paging Indicator (MI) included in the MICH frame. Here, the mobile terminal obtains a remainder value, calculated by dividing a service identifier of the MBMS by the constant value determined by the network, and compares the remainder value with the MI included in the received MICH frame. If the appropriate MI has been included in the MICH frame, the terminal receives an MCCH transmitted during the next DRX cycle.

The network does not transmit the MCCH from a start point of the next DRX cycle. Rather, the MCCH is transmitted with some offset (MCCH offset). The MCCH offset accounts for the situation when mobile terminals receive the PICH frame during the last part of the DRX cycle. When such an event occurs, the mobile terminals receive the corresponding MICH frame during the next DRX cycle temporally. Thus, to make sure that the MICH frame and the MCCH are transmitted without overlap, the network transmits the MCCH with some offset.

Using the MICH indicator proposed in the present invention, the network does not need to always transmit the MICH frame during MBMS paging. Specifically, the network may transmit the MICH frame only when there is information to be transmitted with the MICH frame. If no information exists, the network does not need to transmit the MICH frame. Thus, the efficient use of radio resources can be maximized. Additionally, the PICH frame can be transmitted during every DRX cycle, as in the related art, so that the mobile terminal can accurately determine whether there is paging information or not.

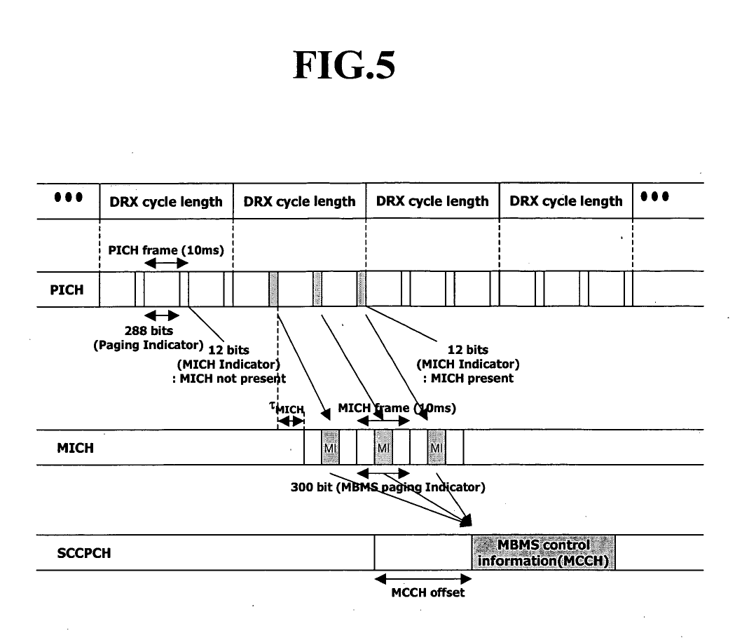

Referring to FIG. 5, a method for transmitting a PICH, a MICH and a MCCH by a network in accordance with a preferred embodiment of the invention is illustrated. In the MBMS paging method of the present invention, a MICH Indicator, located in a PICH frame, indicates whether there is a MICH frame to be received by the mobile terminal. Thus, 12 bits, previously not used in the related art, of a total 300 bits of the PICH frame form one MICH indicator. In this respect, if MBMS services are increasingly provided in a cell and terminals increasingly want to receive the services, the MICH frame can be continuously transmitted and the MICH indicator can be continuously included in the PICH frame.

However, a situation may arise where paging for a service a mobile terminal has not subscribed to is transmitted by the network and the mobile terminal erroneously determines that the paging is for a subscribed service and receives a corresponding MICH frame. Accordingly, a method for transmitting a multi-MICH indicator for reducing such a false alarm is needed.

In the MBMS paging method of the present invention previously described, one MICH indicator is formed with the non-use part, or the last 12 bits, of the PICH. In accordance with another embodiment of the present invention, a multi-MICH indicator transmitting method is employed in an MBMS paging method. Here, the MICH indicator is formed with less than 12 bits and a plurality of MICH indicators are inserted into the non-use part (last 12 bits) of the PICH frame. Furthermore, MIs of the MICH frame are particularly grouped together so that each MICH indicator can indicate a specific MI group. As such, the MIs may further be subdivided to reduce the threat of false alarms. However, because the MICH indicators for indicating such subdivided MI groups would be formed with less than 12 bits, reliability of the MICH indicators are slightly degraded.

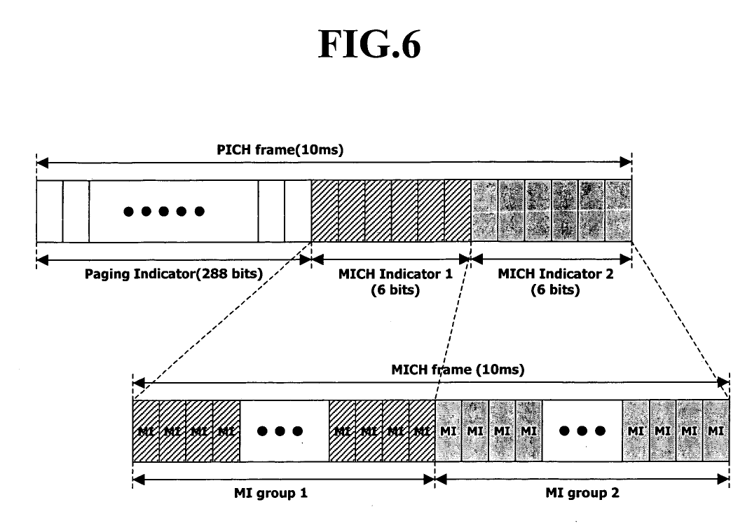

Referring to FIG. 6, a method for using a multiple MICH indicator in accordance with one embodiment of the invention is illustrated. As shown, one MICH indicator comprises 6 bits. Thus, two MICH indicators are included in each PICH frame, wherein each MICH indicator respectively indicates the existence of paging information in an MI group 1 and an MI group 2 of a MICH frame.

The MIs in the MICH frame can be grouped in several ways. For example, of the total 300 bits in the MICH frame, the MIs included in the front 150 bits can be designated group 1 and the MIs included in the rear 150 bits can be designated group 2. Alternatively, even numbered MIs can be designated group 1 and odd numbered MIs can be designated group 2, for instance.

In order to use the multiple MICH indicator method, the mobile terminal should know how the MI group is constructed or how the MI group is related to the MICH indicator. Preferably, the mobile terminal previously determines the MI grouping method or the mobile terminal is informed of the MI grouping through signaling. Furthermore, the mobile terminal should know to which group an MI of a service the terminal has subscribed to belongs and through which MICH indicator the MI is transmitted. Once the mobile terminal recognizes its own MICH indicator, the mobile terminal receives the MICH indicator for every PICH frame and determines whether to receive the MICH frame.

The multiple MICH indicator method is advantageous in that it can save radio resources of the network. For example, if only the MICH indicator 1 is included in the PICH frame of FIG. 6, then the network transmits only the MI group 1 in the corresponding MICH frame. If only the MICH indicator 2 is included, then the network transmits only the MI group 2. Thus, transmission of an unnecessary portion of the MICH frame can be prevented.

As so far described, the MBMS paging method of the present invention has many advantages. For example, since the MICH frame including the MBMS paging information is transmitted after a certain time from the PICH frame, one physical channel receiver can receive both the PICH and the MICH frame. This is advantageous over the related art wherein the mobile terminal requires two physical channel receivers to receive the PICH frame and the MICH frame simultaneously. Thus, complexity of hardware is reduced.

Additionally, since the mobile terminal subscribed to an MBMS receives the MICH frame only when the MICH indicator has been included in the PICH frame, power consumption of the mobile terminal is considerably reduced. This is advantageous over the related art wherein the mobile terminal always receives the MICH frame. Mobile terminal power consumption is a key issue regarding mobile communication systems. Thus, the present invention is expected to contribute greatly to the development of mobile communication systems.

Although the present invention is described in the context of mobile communication, the present invention may also be used in any wireless communication systems using mobile devices, such as PDAs and laptop computers equipped with wireless communication capabilities. Moreover, the use of certain terms to describe the present invention should not limit the scope of the present invention to certain type of wireless communication system, such as UMTS. The present invention is also applicable to other wireless communication systems using different air interfaces and/or physical layers, for example, TDMA, CDMA, FDMA, WCDMA, etc.

The preferred embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.).

Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. A method for receiving a point-to-multipoint service in a wireless communication system, the method comprising:
waking during a discontinuous reception cycle length to receive a paging indication channel frame, the paging indication channel frame comprising a paging indicator and a point-to-multipoint indication channel indicator;
reading the paging indicator in the paging indication channel frame;
reading the point-to-multipoint indication channel indicator in the paging indication channel frame;
receiving a point-to-multipoint indication channel frame if the point-to-multipoint indication channel indicator contained in the paging indication channel frame is associated with the point-to-multipoint service subscribed by a mobile terminal, the point-to-multipoint indication channel frame comprising a point-to-multipoint notification indicator; and
receiving point-to-multipoint control information for the point-to-multipoint service subscribed by the mobile terminal if the point-to-multipoint notification indicator contained in the point-to-multipoint indication channel frame is associated with the point-to-multipoint service subscribed by the mobile terminal.

2. The method of claim 1, further comprising returning to a sleep mode if the paging indicator and the point-to-multipoint indication channel indicator contained in the paging indication channel frame are not associated with the mobile terminal.

3. The method of claim 1, wherein the point-to-multipoint indication channel frame is received after a certain time from the reception of the paging indication channel frame.

4. The method of claim 1, wherein the point-to-multipoint indication channel indicator is contained in the last 12 bits of the paging indication channel frame.

5. The method of claim 1, wherein the mobile terminal reads the point-to-multipoint indication channel frame only when the point-to-multipoint notification indicator is included in the point-to-multipoint indication channel frame.

6. The method of claim 1, further comprising:
calculating a remainder value by dividing the mobile terminal's identity by a constant value determined by a network;
determining whether the paging indicator is associated with the mobile terminal by comparing the paging indicator with the remainder value; and
receiving an associated paging channel frame containing mobile terminal paging information if the paging indicator is determined to be associated with the mobile terminal.

7. The method of claim 1, further comprising:
calculating a remainder value by dividing a point-to-multipoint service identifier by a constant value determined by a network;
determining whether the point-to-multipoint notification indicator is associated with the point-to-multipoint service subscribed by the mobile terminal by comparing the point-to-multipoint notification indicator with the remainder value; and
receiving a point-to-multipoint control channel containing the point-to-multipoint control information if the point-to-multipoint notification indicator is determined to be associated with the point-to-multipoint service subscribed by the mobile terminal.

8. The method of claim 7, wherein the point-to-multipoint control channel is received after a certain time from the beginning of the next discontinuous reception cycle.

9. A method for receiving a point-to-multipoint service in a wireless communication system, the method comprising:
waking during a discontinuous reception cycle length to receive a paging indication channel frame, the paging indication channel frame comprising a paging indicator and a plurality of point-to-multipoint indication channel indicators;
reading the paging indicator contained in the paging indication channel frame;
reading the plurality of point-to-multipoint indication channel indicators contained in the paging indication channel frame;
receiving a point-to-multipoint indication channel frame if at least one of the plurality of point-to-multipoint indication channel indicators contained in the paging indication channel frame is associated with the point-to-multipoint service subscribed by a mobile terminal, the point-to-multipoint indication channel frame comprising at least one point-to-multipoint notification indicator group able to be indicated by at least one of the plurality of point-to-multipoint indication channel indicators contained in the paging indication channel frame; and
receiving point-to-multipoint control information for the point-to-multipoint service subscribed by the mobile terminal if at least one point-to-multipoint notification indicator in the at least one point-to-multipoint notification indicator group contained in the point-to-multipoint indication channel frame is associated with the point-to-multipoint service subscribed by the mobile terminal.

10. The method of claim 9, further comprising returning to a sleep mode if the paging indicator and the plurality of point-to-multipoint indicator channel indicators contained in the paging indication channel frame are not associated with a service subscribed by the mobile terminal.

11. The method of claim 9, wherein the point-to-multipoint indication channel frame is received after a certain time from the reception of the paging indication channel frame.

12. The method of claim 9, wherein the relationship between the at least one point-to-multipoint notification indicator group contained in the point-to-multipoint indication channel frame and the plurality of point-to-multipoint indication channel indicators contained in the paging indication channel frame is signaled to the mobile terminal by a network.

13. The method of claim 9, wherein the plurality of point-to-multipoint indication channel indicators are contained in the last 12 bits of the paging indication channel frame.

14. The method of claim 9, wherein each of the plurality of point-to-multipoint indication channel indicators is formed with less than 12 bits.

15. The method of claim 9, wherein two point-to-multipoint indication channel indicators comprising 6 bits each are included in the paging indication channel frame.

16. The method of claim 15, wherein the two point-to-multipoint indication channel indicators respectively indicate two point-to-multipoint notification indicator groups in the point-to-multipoint indication channel frame.

17. The method of claim 9, wherein the mobile terminal reads the point-to-multipoint indication channel frame only when a point-to-multipoint notification indicator is included in the point-to-multipoint indication channel frame.

18. The method of claim 9, further comprising:
calculating a remainder value by dividing the mobile terminal's identity by a constant value determined by a network;
determining whether the paging indicator is associated with the mobile terminal by comparing the paging indicator with the remainder value; and
receiving an associated paging channel frame containing mobile terminal paging information if the paging indicator is determined to be associated with the mobile terminal.

19. The method of claim 9, further comprising:
calculating a remainder value by dividing a point-to-multipoint service identifier by a constant value determined by a network;
determining whether the at least one point-to-multipoint notification indicator is associated with the point-to-multipoint service subscribed by the mobile terminal by comparing the at least one point-to-multipoint notification indicator with the remainder value; and
receiving a point-to-multipoint control channel containing the point-to-multipoint control information if the at least one point-to-multipoint notification indicator is determined to be associated with the point-to-multipoint service subscribed by the mobile terminal.

20. The method of claim 19, wherein the point-to-multipoint control channel is received after a certain time from the beginning of the next discontinuous reception cycle.

21. The method of claim 9, wherein point-to-multipoint notification indicators are grouped together in the at least one point-to-multipoint notification indicator group so that each of the plurality of point-to-multipoint indication channel indicators contained in the paging indication channel frame can indicate a specific point-to-multipoint notification indicator group.

22. The method of claim 21, wherein the point-to-multipoint notification indicators are grouped such that the point-to-multipoint notification indicators included in the front half of the point-to-multipoint indication channel frame are designated a first group and the point-to-multipoint notification indicators included in the rear half of the point-to-multipoint indication channel frame are designated a second group.

23. The method of claim 21, wherein the point-to-multipoint notification indicators are grouped such that the even-numbered point-to-multipoint notification indicators included in the point-to-multipoint indication channel frame are designated a first group and the odd-numbered point-to-multipoint notification indicators included in the point-to-multipoint indication channel frame are designated a second group.

24. A method for transmitting a point-to-multipoint service in a wireless communication system, the method comprising:
transmitting a paging indication channel frame, the paging indication channel frame comprising a paging indicator; and
transmitting at least one point-to-multipoint indication channel frame after a certain time from the transmission of the paging indication channel frame, the at least one point-to-multipoint indication channel frame comprising at least one point-to-multipoint notification indicator.

25. The method of claim 24, wherein the paging indication channel frame further comprises a point-to-multipoint indication channel indicator.

26. The method of claim 24, further comprising transmitting point-to-multipoint control information for the point-to-multipoint service after transmitting the point-to-multipoint indication channel frame having the at least one point-to-multipoint notification indicator corresponding to the point-to-multipoint control information.

27. The method of claim 24, wherein the at least one point-to-multipoint indication channel frame is transmitted only when point-to-multipoint paging information is included in the point-to-multipoint indication channel frame.

28. A method for transmitting a point-to-multipoint service in a wireless communication system, the method comprising:
transmitting a paging indication channel frame during a discontinuous reception cycle length of a mobile terminal, the paging indication channel frame comprising a paging indicator and a point-to-multipoint indication channel indicator;
transmitting a point-to-multipoint indication channel frame if the point-to-multipoint indication channel indicator contained in the paging indication channel frame is associated with the point-to-multipoint service subscribed by a mobile terminal, the point-to-multipoint indication channel frame comprising a point-to-multipoint notification indicator; and
transmitting point-to-multipoint control information for the point-to-multipoint service subscribed by the mobile terminal if the point-to-multipoint notification indicator contained in the point-to-multipoint indication channel frame is associated with the point-to-multipoint service subscribed by the mobile terminal.

29. The method of claim 28, wherein the point-to-multipoint indication channel frame is transmitted after a certain time from the transmission of the paging indication channel frame.

30. The method of claim 28, wherein the point-to-multipoint indication channel indicator is contained in the last 12 bits of the paging indication channel frame.

31. The method of claim 28, wherein a network transmits the point-to-multipoint indication channel frame only when point-to-multipoint paging information is included in the point-to-multipoint indication channel frame.

32. The method of claim 28, wherein the control information is transmitted through a point-to-multipoint control channel, the point-to-multipoint control channel being transmitted after a certain time from the beginning of the next discontinuous reception cycle.

33. A method for transmitting a point-to-multipoint service in a wireless communication system, the method comprising:
transmitting a paging indication channel frame during a discontinuous reception cycle length of a mobile terminal, the paging indication channel frame comprising a paging indicator and a plurality of point-to-multipoint indication channel indicators;
transmitting a point-to-multipoint indication channel frame if at least one of the plurality of point-to-multipoint indication channel indicators contained in the paging indication channel frame is associated with the point-to-multipoint service subscribed by the mobile terminal, the point-to-multipoint indication channel frame comprising at least one point-to-multipoint notification indicator group able to be indicated by at least one of the plurality of point-to-multipoint indication channel indicators contained in the paging indication channel frame; and
transmitting point-to-multipoint control information for the point-to-multipoint service subscribed by the mobile terminal if at least one point-to-multipoint notification indicator in the at least one point-to-multipoint notification indicator group contained in the point-to-multipoint indication channel frame is associated with the point-to-multipoint service subscribed by the mobile terminal.

34. The method of claim 33, wherein the point-to-multipoint indication channel frame is transmitted after a certain time from the transmission of the paging indication channel frame.

35. The method of claim 33, wherein the relationship between the at least one point-to-multipoint notification indicator group contained in the point-to-multipoint indication channel frame and the plurality of point-to-multipoint indication channel indicators contained in the paging indication channel frame is signaled to the mobile terminal by a network.

36. The method of claim 33, wherein the plurality of point-to-multipoint indication channel indicators are contained in the last 12 bits of the paging indication channel frame.

37. The method of claim 33, wherein each of the plurality of point-to-multipoint indication channel indicators is formed with less than 12 bits.

38. The method of claim 33, wherein two point-to-multipoint indication channel indicators comprising 6 bits each are included in the paging indication channel frame.

39. The method of claim 38, wherein the two point-to-multipoint indication channel indicators respectively indicate two point-to-multipoint notification indicator groups in the point-to-multipoint indication channel frame.

40. The method of claim 33, wherein a network transmits the point-to-multipoint indication channel frame only when point-to-multipoint paging information is included in the point-to-multipoint indication channel frame.

41. The method of claim 33, wherein the control information is transmitted through a point-to-multipoint control channel, the point-to-multipoint control channel being transmitted after a certain time from the beginning of the next discontinuous reception cycle.

42. The method of claim 33, wherein point-to-multipoint notification indicators are grouped together in the at least one point-to-multipoint notification indicator group so that each of the plurality of point-to-multipoint indication channel indicators contained in the paging indication channel frame can indicate a specific point-to-multipoint notification indicator group.

43. The method of claim 42, wherein the point-to-multipoint notification indicators are grouped such that the point-to-multipoint notification indicators included in the front half of the point-to-multipoint indication channel frame are designated a first group and the point-to-multipoint notification indicators included in the rear half of the point-to-multipoint indication channel frame are designated a second group.

44. The method of claim 42, wherein the point-to-multipoint notification indicators are grouped such that the even-numbered point-to-multipoint notification indicators included in the point-to-multipoint indication channel frame are designated a first group and the odd-numbered point-to-multipoint notification indicators included in the point-to-multipoint indication channel frame are designated a second group.

45. The method of claim 42, wherein a network transmits the at least one point-to-multipoint notification indicator group only if a corresponding point-to-multipoint indication channel indicator is included in the paging indication channel frame.

46. An apparatus for receiving a point-to-multipoint service in a wireless communication system, the apparatus comprising:
a processor adapted to wake the apparatus during a discontinuous reception cycle length and a receiver adapted to receive a paging indication channel frame, the paging indication channel frame comprising a paging indicator and a point-to-multipoint indication channel indicator;
the processor adapted to read the paging indicator contained in the paging indication channel frame;
the processor adapted to read the point-to-multipoint indication channel indicator contained in the paging indication channel frame;
the receiver adapted to receive a point-to-multipoint indication channel frame if the point-to-multipoint indication channel indicator contained in the paging indication channel frame is associated with the point-to-multipoint service subscribed by a mobile terminal, the point-to-multipoint indication channel frame comprising a point-to-multipoint notification indicator; and
the receiver adapted to receive point-to-multipoint control information for the point-to-multipoint service subscribed by the mobile terminal if the point-to-multipoint notification indicator contained in the point-to-multipoint indication channel frame is associated with the point-to-multipoint service subscribed by the mobile terminal.

47. An apparatus for receiving a point-to-multipoint service in a wireless communication system, the apparatus comprising:
a processor adapted to wake during a discontinuous reception cycle length and a receiver adapted to receive a paging indication channel frame, the paging indication channel frame comprising a paging indicator and a plurality of point-to-multipoint indication channel indicators;
the processor adapted to read the paging indicator contained in the paging indication channel frame;
the processor adapted to read the plurality of point-to-multipoint indication channel indicators contained in the paging indication channel frame;
the receiver adapted to receive a point-to-multipoint indication channel frame if at least one of the plurality of point-to-multipoint indication channel indicators contained in the paging indication channel frame is associated with the point-to-multipoint service subscribed by a mobile terminal, the point-to-multipoint indication channel frame comprising at least one point-to-multipoint notification indicator group able to be indicated by at least one of the plurality of point-to-multipoint indication channel indicators contained in the paging indication channel frame; and
the receiver adapted to receive point-to-multipoint control information for the point-to-multipoint service subscribed by the mobile terminal if at least one point-to-multipoint notification indicator in the at least one point-to-multipoint notification indicator group contained in the point-to-multipoint indication channel frame is associated with the point-to-multipoint service subscribed by the mobile terminal.

48. A network for transmitting a point-to-multipoint service in a wireless communication system, the network comprising:
a transmitter adapted to transmit a paging indication channel frame, the paging indication channel frame comprising a paging indicator; and
the transmitter adapted to transmit at least one point-to-multipoint indication channel frame after a certain time from the transmission of the paging indication channel frame, the at least one point-to-multipoint indication channel frame comprising at least one point-to-multipoint notification indicator.

49. A network for transmitting a point-to-multipoint service in a wireless communication system, the network comprising:
a transmitter adapted to transmit a paging indication channel frame during a discontinuous reception cycle length of a mobile terminal, the paging indication channel frame comprising a paging indicator and a point-to-multipoint indication channel indicator;
the transmitter adapted to transmit a point-to-multipoint indication channel frame if the point-to-multipoint indication channel indicator contained in the paging indication channel frame is associated with the point-to-multipoint service subscribed by a mobile terminal, the point-to-multipoint indication channel frame comprising a point-to-multipoint notification indicator; and
the transmitter adapted to transmit point-to-multipoint control information for the point-to-multipoint service subscribed by the mobile terminal if the point-to-multipoint notification indicator contained in the point-to-multipoint indication channel frame is associated with the point-to-multipoint service subscribed by the mobile terminal.

50. A network for transmitting a point-to-multipoint service in a wireless communication system, the network comprising:
a transmitter adapted to transmit a paging indication channel frame during a discontinuous reception cycle length of a mobile terminal, the paging indication channel frame comprising a paging indicator and a plurality of point-to-multipoint indication channel indicators;
the transmitter adapted to transmit a point-to-multipoint indication channel frame if at least one of the plurality of point-to-multipoint indication channel indicators contained in the paging indication channel frame is associated with the point-to-multipoint service subscribed by the mobile terminal, the point-to-multipoint indication channel frame comprising at least one point-to-multipoint notification indicator group able to be indicated by at least one of the plurality of point-to-multipoint indication channel indicators contained in the paging indication channel frame; and
the transmitter adapted to transmit point-to-multipoint control information for the point-to-multipoint service subscribed by the mobile terminal at least one point-to-multipoint notification indicator in the at least one point-to-multipoint notification indicator group contained in the point-to-multipoint indication channel frame is associated with the point-to-multipoint service subscribed by the mobile terminal.
